(19) United States
(12) Patent Application Publication
(10) Pub. No.: US 2002/0139669 A1
(43) Pub. Date: Oct. 3, 2002

(54) Solid electrolyte type gas sensor

(75) Inventor: Shigeyuki Kimura, Saitama (JP)

Correspondence Address: MORGAN LEWIS & BOCKIUS LLP, 1111 PENNSYLVANIA AVENUE NW, WASHINGTON, DC, 20004, US

(73) Assignee: Akebono Brake Industry Co., Ltd.

(21) Appl. No.: 10/112,767

(22) Filed: Apr. 2, 2002

(30) Foreign Application Priority Data
Apr. 3, 2001 (JP) P2001-104393

(51) Int. Cl. G01N 27/407

(52) U.S. Cl. 204/424; 204/426

(57) ABSTRACT

A solid electrolyte type gas sensor including an ionically-conductive material, a reference electrode and a sensing electrode, wherein the sensing electrode is obtained by sintering an alkaline metal salt in a gas atmosphere containing a predetermined high concentration gas. The ionically-conductive material is pressure-bonded to the reference electrode and the sensing electrode. The reference electrode and the sensing electrode are a sintered mixture including Au and are ground on the surface thereof in contact with the ionically-conductive material.

### BACKGROUND OF THE INVENTION

1. Field of the Invention

The present invention relates to a solid electrolyte type gas sensor for use in the measurement of CO₂ concentration, etc. in the art of gardening in facilities, environmental hygiene, prevention of disasters, in the industrial field, etc. and more particularly to a small-sized solid electrolyte type gas sensor which is designed to be less subject to the effect of inhibiting gaseous components and water vapor, which is the greatest difficulty in the practical use of solid electrolyte type gas sensor.

2. Description of the Related Art

In order to cope with the atmospheric pollution, the extensive development of gas sensors which can measure the concentration of CO₂ or NOx and SOx in gas phase has been recently under way. One of these gas sensor elements is a so-called solid electrolyte type gas sensor including a sensing electrode and a reference electrode provided on the surface of a solid electrolyte (ionically-conductive material) (Japanese Patent Unexamined Publications No. Hei. 4-344457 and No. Hei. 4-213049, for example).

However, when the atmosphere has inhibiting components (inhibiting gaseous components) and water vapor mixed therein, the solid electrolyte type gas sensor for the measurement of atmosphere as mentioned above is subject to the entrance of these inhibiting components and water vapor into the area where an ionically-conductive material and a sensing electrode or reference electrode as main components of the sensor come in close contact with each other causing the reaction of these parts with these inhibiting components and water vapor. As a result, it becomes impossible to accurately measure the concentration of the gas to be measured. In other words, it has been made obvious that the solid electrolyte type gas sensor for the measurement of atmosphere is subject to the entrance of inhibiting gases of water, ethanol, silicone, etc. in the atmosphere in the sensor parts, if they have a low molding density. Accordingly, the sensor constituents are contaminated and deteriorated in performance. Such an ethanol comes in a large amount from alcoholic drinks or fermented products, and silicon comes in a large amount from hair cream, etc. to form inhibiting components.

As a countermeasure for removing these inhibiting components it has been usually practiced to cover the sensor by a film such as filter so that the sensor is isolated from these inhibiting components. Although this countermeasure has a great effect on powder materials, it has a small effect on gaseous materials. Further, a problem can arise that both these materials clog the filter and results in the reduction of a life of the sensor.

### SUMMARY OF THE INVENTION

Therefore, a purpose of the present invention is to solve the aforementioned problems by providing a solid electrolyte type gas sensor having the following improvements. The formed sensing electrode is sintered in a gas atmosphere in equilibrium therewith so that the purity of the material is maintained with preventing the production of oxides or hydroxides in the sensing electrode itself. Further, by enhancing the molding density of the sensing electrode and the reference electrode, the entrance of water vapor into the interior of the sensing electrode and the reference electrode can be prevented. Moreover, by grinding the sensing electrode and the reference electrode on the surface thereof in contact with the ionically-conductive material (connecting interface), the entrance of inhibiting gases into the interface can be prevented. Different materials (sensing electrode, ionically-conductive material, reference electrode) are not baked at a temperature of not lower than the working temperature but are merely pressure-bonded to each other.

In view of the above problems, there is provided a solid electrolyte type gas sensor including an ionically-conductive material, a reference electrode and a sensing electrode, wherein the sensing electrode is obtained by sintering an oxygen acid salt of alkaline metal in a gas atmosphere containing a predetermined high concentration gas and the ionically-conductive material is pressure-bonded to the reference electrode and the sensing electrode.

Preferably, in the above solid electrolyte type gas sensor, the reference electrode and the sensing electrode each are a sintered mixture including Au and are ground on the surface thereof in contact with the ionically-conductive material.

Further preferably, in the above solid electrolyte type gas sensor, the oxygen acid salt of alkaline metal is one of carbonate of alkaline metal, nitrate of alkaline metal and sulfate of alkaline metal.

Preferably, in the above solid electrolyte type gas sensor, the sensing electrode is obtained by sintering a carbonate of alkaline metal in a gas atmosphere containing a high concentration CO₂ gas.

Alternatively, in the above solid electrolyte type gas sensor, the sensing electrode is obtained by sintering a nitrate of alkaline metal in a gas atmosphere containing a high concentration NO₂ gas.

Alternatively, in the above solid electrolyte type gas sensor, the sensing electrode is obtained by sintering a sulfate of alkaline metal in a gas atmosphere containing a high concentration SO₂ gas.

### BRIEF DESCRIPTION OF THE DRAWINGS

FIG. 1 is a diagram of the structure of a solid electrolyte type gas sensor according to an embodiment of the invention.

FIG. 2(a) is a graph, according to the present invention, showing the change of the electromotive force of the solid electrolyte type gas sensor with time.

FIG. 2(b) is a graph, according to the present invention, showing the change of response time with time.

FIG. 2(c) is a graph, according to the conventional gas sensor, showing the change of the electromotive force of the solid electrolyte type gas sensor with time.

FIG. 2(d) is a graph, according to the conventional gas sensor, showing the change of response time with time.

### DETAILED DESCRIPTION OF THE PREFERRED EMBODIMENTS

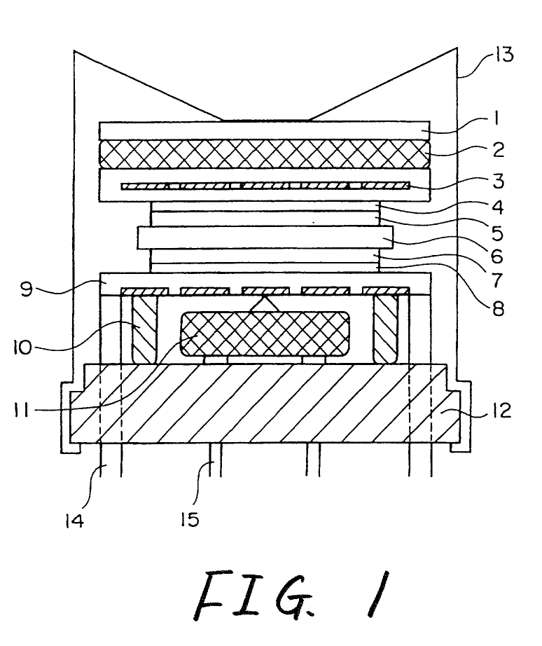

Referring to embodiments of the invention in connection with the drawings, FIG. 1 is a diagram of the structure of a solid electrolyte type gas sensor according to an embodiment of the invention.

In the drawing, the reference numeral 1 indicates an alumina plate, the reference numeral 2 indicates an upper thermal insulating material, the reference numeral 3 indicates an upper heater, the reference numeral 4 indicates an Au metal gauze for reference electrode current collector, the reference numeral 5 indicates a reference electrode, the reference numeral 6 indicates an ionically-conductive material, the reference numeral 7 indicates a sensing electrode, the reference numeral 8 indicates an Au metal gauze for sensing electrode current collector, the reference numeral 9 indicates a lower heater, the reference numeral 10 indicates a pyrex ring, the reference numeral 11 indicates a lower thermal insulating material, the reference numeral 12 indicates a stem, the reference numeral 13 indicates a leaf spring, the reference numeral 14 indicates a lead pin, and the reference numeral 15 indicates a thermocouple. In this sensor structure, a pyrex ring (glass ring) containing the lower thermal insulating material 11 is disposed on the stem 12. The pyrex ring is then covered by the lower heater 9. A thermocouple is then disposed in the pyrex ring. On the lower heat 9 is disposed the sensing electrode current collector 8 on which the sensing electrode 7, the ionically-conductive material 6 and the reference electrode 5 are disposed. On the reference electrode 5 is disposed the reference electrode current collector 4 on which the upper heater 3, the upper thermal insulating material 2 and the alumina plate 1 are disposed. These elements are pressed by the spring 13 from above.

During the assembly of these elements, care is preferably exercised to prevent the shortcircuiting of lead wires of the sensing electrode 7, the reference electrode 5, etc. Further, it is preferred that the various elements be arranged in position on the central part of the stem and then pressed by the spring 13 under a predetermined pressure while being prevented from deviating in position. The pushing force of the spring 13 is determined by the size and disposition of the elements but may be arbitrary so far as it gives a contact resistance of not greater than a predetermined value. Therefore, the pushing force developed by the energization (elastic force) by the spring (elastic material) can have a tolerance falling within a relatively wide range. While as the spring there is used a leaf spring in the present embodiment, a coiled spring or the like may be used so far as it can press the entire elements. Further, the sensor is preferably covered by a screen cover or the like allowing the passage of the gas to be sensed to protect the aforementioned various parts.

As the sensing electrode 7 and the reference electrode 5 among the aforementioned elements constituting the gas sensor, there are each used one obtained by sintering a high purity material to a high density despite of its low hardness to prevent the denaturation thereof by inhibiting gases. In some detail, in the case where as the material of sensing electrode there is used Li₂CO₃, the sensing electrode which has been formed can be sintered in a gas atmosphere in equilibrium therewith (e.g., atmosphere containing 10% CO₂) in such a manner that the relative humidity reaches 90% to prevent Li₂CO₃ from undergoing thermal decomposition at high temperatures to produce oxides (Li₂CO₃=Li₂O+CO₂) or to from reacting with water to produce hydroxides (Li₂O +H₂O=2LiOH) . The reference electrode which has been formed is sintered in the atmosphere.

In the case where as the material of sensing electrode there is used a carbonate of alkaline metal, the atmosphere in which the material formed is sintered is a high CO₂ atmosphere. In the case where as the material of sensing electrode there is used a nitrate of alkaline metal, the atmosphere in which the material formed is sintered is a high NO₂ atmosphere. In the case where as the material of sensing electrode there is used a sulfate of alkaline metal, the atmosphere in which the material formed is sintered is a high SO₂ atmosphere. In the case where as the material of sensing electrode there is used a carbonate of alkaline metal, a CO₂ sensor is produced. In the case where as the material of sensing electrode there is used a nitrate of alkaline metal, an NOₓ sensor is produced. In the case where as the material of sensing electrode there is used a sulfate of alkaline metal, an SOₓ sensor is produced.

Further, the connection of the sensing electrode and the reference electrode to the ionically-conductive material is accomplished merely by pressure-bonding by a spring or the like as previously mentioned. No baking process is effected at a temperature of not lower than the working temperature to prevent the reaction of the main parts with each other.

Moreover, in order to cause the ionically-conductive material to come in close contact with the sensing electrode and the reference electrode, the sensing electrode and the reference electrode include Au incorporated therein to have a flexible structure. Further, the sensing electrode and the reference electrode are ground on the surface thereof in contact with the ionically-conductive material to have an enhanced surface contact that prevents the entrance of inhibiting gases and water vapor into the interface.

Examples of the preparation of sensing electrode and reference electrode will be described hereinafter.

(Sensing Electrode)

Li₂CO₃ and a wt-% Au are mixed, pre-press molded, and then sintered at a temperature of 650° C. in air containing 10% CO₂ under no pressure. The material thus sintered is then ground on the surface thereof to have a smooth surface.

(Reference Electrode)

LiFeO₂, β mol-% LiFe₅O₆ and γ wt-% Au are mixed, pre-press molded, and then sintered at a temperature of 900° C. in the atmosphere under no pressure. The material thus sintered is then ground on the surface thereof to have a smooth surface.

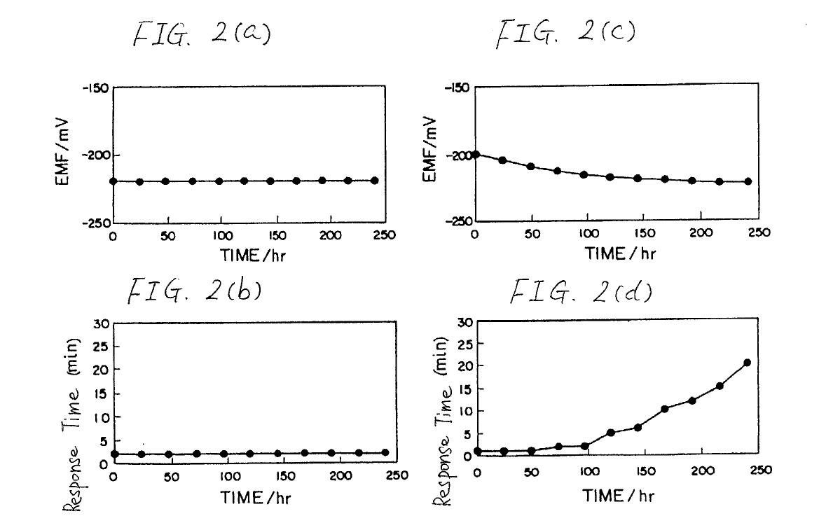

Examples of comparison of a solid electrolyte type gas sensor having the aforementioned structure (example) with a conventional solid electrolyte type gas sensor (comparative example) are shown in FIGS. 2(a) to 2(d). Specifically, FIGS. 2(a) and 2(b) show results according to the present invention (example), and FIGS. 2(c) and 2(d) show results according to the conventional gas sensor (comparative example). FIG. 2(a) and FIG. 2(c) show the change of the electromotive force of the solid electrolyte type gas sensor with time, and FIG. 2(b) and 2(d) show the change of response time with time. In these examples of comparison, the solid electrolyte type gas sensor of the present invention includes a sensing electrode obtained by sintering in a high CO₂ atmosphere (air containing 10% CO₂). The sensing electrode and the reference electrode were ground on the surface thereof in contact with the lithium ionically-conductive material. The sensing electrode and the reference electrode were pressure-bonded to the lithium ionically-conductive material. On the other hand, the conventional solid electrolyte type gas sensor was assembled by bonding a lithium ionically-conductive material to sintered sensing and reference electrodes at high temperature by baking in the atmosphere.

Referring to the results of the operation test of gas sensor at a temperature of 500° C. in wet air, as shown in FIGS. 2(a) to 2(d), the change of the electromotive force of the solid electrolyte type gas sensor according to the invention and the conventional gas sensor with time shows that the solid electrolyte type gas sensor according to the invention has a stable electromotive force while the comparative example shows a great drop of electromotive force.

Further, the change of response time with time shows that the solid electrolyte type gas sensor according to the invention shows no change of response time while the comparative example has a prolonged response time.

As mentioned above, in accordance with the present invention, as can be seen in FIGS. 2(a) and 2(b), the response and sensor properties show no change over an extended period of time. Accordingly, it is possible to prolong a life of the sensor without impairing the response.

As the unit for pressing the various elements there may be used any units (e.g., clamping by thread) other than spring so far as it can exhibit a predetermined pushing force with respect to the various elements. Further, the present invention is not limited to the aforementioned embodiment. Other embodiments of assembly may be employed so far as similar function can be realized.

As mentioned above, in accordance with the present invention, the sensing electrode material is sintered to a high density (relative density: about 90%) by a preparation process that prevents the decomposition of the sensing electrode material itself (specifically, high CO₂ concentration air containing 10% CO₂). Different materials are not baked at a temperature of not lower than the working temperature but are merely pressure-bonded to each other. Further, the sensing electrode and the reference electrode are ground on the surface thereof in contact with the ionically-conductive material. In this arrangement, combined with the flexible structure developed by the incorporation of Au in the sensing electrode and the reference electrode, the various surfaces can come in close contact with each other to prevent the entrance of inhibiting gases and water vapor thereinto. Accordingly, it is possible to prevent the entrance of unnecessary inhibiting components into the sensor element and the deterioration of the sensor element. Further, it is possible to prevent or retard the deterioration of the sensor performance and hence prolong the life of the sensor.

What is claimed is:

1. A solid electrolyte type gas sensor comprising:
an ionically-conductive material;
a reference electrode; and
a sensing electrode,
wherein said sensing electrode is obtained by sintering an oxygen acid salt of alkaline metal in a gas atmosphere containing a predetermined high concentration gas and said ionically-conductive material is pressure-bonded to said reference electrode and said sensing electrode.

2. The solid electrolyte type gas sensor according to claim 1,
wherein said reference electrode and said sensing electrode are a sintered mixture including Au and are ground on the surface thereof in contact with said ionically-conductive material.

3. The solid electrolyte type gas sensor according to claim 2,
wherein said oxygen acid salt of alkaline metal is one of carbonate of alkaline metal, nitrate of alkaline metal and sulfate of alkaline metal.

4. The solid electrolyte type gas sensor according to claim 3,
wherein said sensing electrode is obtained by sintering a carbonate of alkaline metal in a gas atmosphere containing a high concentration CO₂ gas.

5. The solid electrolyte type gas sensor according to claim 3,
wherein said sensing electrode is obtained by sintering a nitrate of alkaline metal in a gas atmosphere containing a high concentration NO₂ gas.

6. The solid electrolyte type gas sensor according to claim 3,
wherein said sensing electrode is obtained by sintering a sulfate of alkaline metal in a gas atmosphere containing a high concentration SO₂ gas.
